(19) United States
(12) Patent Application Publication
(10) Pub. No.: US 2026/0037899 A1
(43) Pub. Date: Feb. 5, 2026

(54) COMPUTING DEVICE FOR DETERMINING AND PROVIDING RATINGS OF THE SKILLS OF A CONTRACTOR

(71) Applicant: Skilled Pro Alliance Inc., Wichita, KS (US)

(72) Inventors: Paul G. Stuart, JR., Andover, KS (US); Daniel E. Drouhard, Wichita, KS (US); Brent Mitchell, Lenexa, KS (US)

(21) Appl. No.: 19/355,593

(22) Filed: Oct. 10, 2025

Related U.S. Application Data
(63) Continuation of application No. 18/254,935.
(60) Provisional application No. 63/119,077, filed on Nov. 30, 2020.

(51) Int. Cl. G06Q 10/0639

(52) U.S. Cl. CPC G06Q 10/0639

(57) ABSTRACT

A computer-implemented method for determining a skill rating of a contractor comprises receiving experience data and training data; determining whether there is any training data; if there is no training data, then determining the skill rating as a maximum value of the skill rating times a constant; if there is some training data, then determining a plurality of evaluation scores, determining a plurality of category evaluation scores, determining a plurality of filtered category evaluation scores, determining an experience total score as a sum of the filtered category evaluation scores, determining an experience factor using the experience total score as an input, and determining the skill rating as a product of the maximum value of the skill rating and the experience factor.

### RELATED APPLICATION

The current patent application is a continuation patent application which claims priority benefit, with regard to all common subject matter, of U.S. Non-Provisional application Ser. No. 18/254,935, titled “COMPUTING DEVICE FOR DETERMINING AND PROVIDING RATINGS OF THE SKILLS OF A CONTRACTOR” and filed May 30, 2023; which is a National Stage Entry that claims priority benefit to PCT Application No. PCT/US2021/060926, titled “COMPUTING DEVICE FOR DETERMINING AND PROVIDING RATINGS OF THE SKILLS OF A CONTRACTOR” and filed Nov. 29, 2021; which claims priority benefit, with regard to all common subject matter, to U.S. Provisional Application titled “COMPUTING DEVICE FOR DETERMINING AND PROVIDING RATINGS OF THE SKILLS OF A CONTRACTOR”, Ser. No. 63/119,077, filed Nov. 30, 2020. The prior applications are hereby incorporated by reference, in their entirety, into the current patent application.

### FIELD OF THE INVENTION

Embodiments of the current invention relate to computing devices programmed or configured to determine and provide ratings of the skills of a contractor.

### BACKGROUND

Builders or contract managers who are seeking contractors to work as subcontractors to complete a building project often search various websites. Those websites typically have ratings of contractors that are based on, or provided directly by, previous customers' opinions. The ratings are subjective and may be more influenced by the customer's personal impression of the contractor instead of the quality of the work performed. Thus, a good job by the contractor may be underrated because the customer did not like the contractor's demeanor, while a bad job may be overrated because the customer personally liked the contractor or was afraid to be critical. As a result, it is difficult for builders or contract managers to find objective evaluations of contractors' skills and abilities.

### SUMMARY OF THE INVENTION

Embodiments of the current invention address one or more of the above-mentioned problems and provide a distinct advance in the art of computer-implemented data processing to objectively evaluate data representing a professional experience to determine the skills of a contractor. Specifically, embodiments of the current invention provide a method executed on a computing device for evaluating experience and training data to determine a skill rating of the contractor. The method includes receiving background information on the contractor that the builder or contract manager does not have access to and would not be aware of. The background information includes a history of work experience and training of the contractor. The work experience and training, instead of personal opinions, is utilized to determine the skill rating of the contractor.

One embodiment of the method broadly comprises receiving experience data and training data regarding the contractor's professional experience; determining whether there is any training data; if there is no training data, then determining the skill rating as a product of a years active factor and a years active filter; if there is some training data, then performing the following: determining a plurality of evaluation scores, each evaluation score determined for a successive one of a plurality of activities related to the training data; determining a plurality of category evaluation scores, each category evaluation score being a sum of the evaluation scores for a successive one of a plurality of categories; determining a plurality of filtered category evaluation scores, each filtered category evaluation score being a product of a successive one of the category evaluation scores and a successive one of a plurality of filters; determining an experience total score as a sum of the filtered category evaluation scores; determining an experience factor using the experience total score as an input; and determining the skill rating as a product of the maximum value of the skill rating and the experience factor.

Another embodiment of the method broadly comprises receiving experience data and training data regarding the contractor's professional experience; determining whether there is any training data; if there is no training data, then determining the skill rating as a product of a years active factor and a years active filter; if there is some training data, then performing the following: verifying that the training data is accurate; verifying that the training data is approved; determining a discipline of the contractor; determining a plurality of evaluation scores, each evaluation score determined for a successive one of a plurality of activities related to the training data; determining a plurality of category evaluation scores, each category evaluation score being a sum of the evaluation scores for a successive one of a plurality of categories; determining a plurality of filtered category evaluation scores, each filtered category evaluation score being a product of a successive one of the category evaluation scores and a successive one of a plurality of filters; determining an experience total score as a sum of the filtered category evaluation scores; determining an experience factor using the experience total score as an input; and determining the skill rating as a product of the maximum value of the skill rating and the experience factor.

Yet another embodiment of the method broadly comprises receiving experience data and training data regarding the contractor's professional experience; determining whether there is any training data; if there is no training data, then determining the skill rating as a product of a years active factor and a years active filter; if there is some training data, then performing the following: verifying that the training data is accurate; removing any training data that is not accurate; verifying that the training data is approved; removing any training data that is not approved; determining a discipline of the contractor; determining a plurality of evaluation scores, each evaluation score determined for a successive one of a plurality of activities related to the training data, a value of each evaluation score varying according to the discipline; determining a plurality of category evaluation scores, each category evaluation score being a sum of the evaluation scores for a successive one of a plurality of categories; determining a plurality of filtered category evaluation scores, each filtered category evaluation score being a product of a successive one of the category evaluation scores and a successive one of a plurality of filters, a value of each filter varying according to the category; determining an experience total score as a sum of the filtered category evaluation scores; determining an experience factor using the experience total score as an input; and determining the skill rating as a product of the maximum value of the skill rating and the experience factor.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an environmental view of several embodiments of a computing device programmed and/or configured for determining and providing ratings of the skills of a contractor;

FIG. 2 is a schematic block diagram of various electronic components of the computing device;

FIG. 3A is a listing of a first portion of the steps of a method for determining a skill rating of a contractor; and

FIG. 3B is a listing of a second portion of the steps of the method for determining the skill rating of a contractor.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

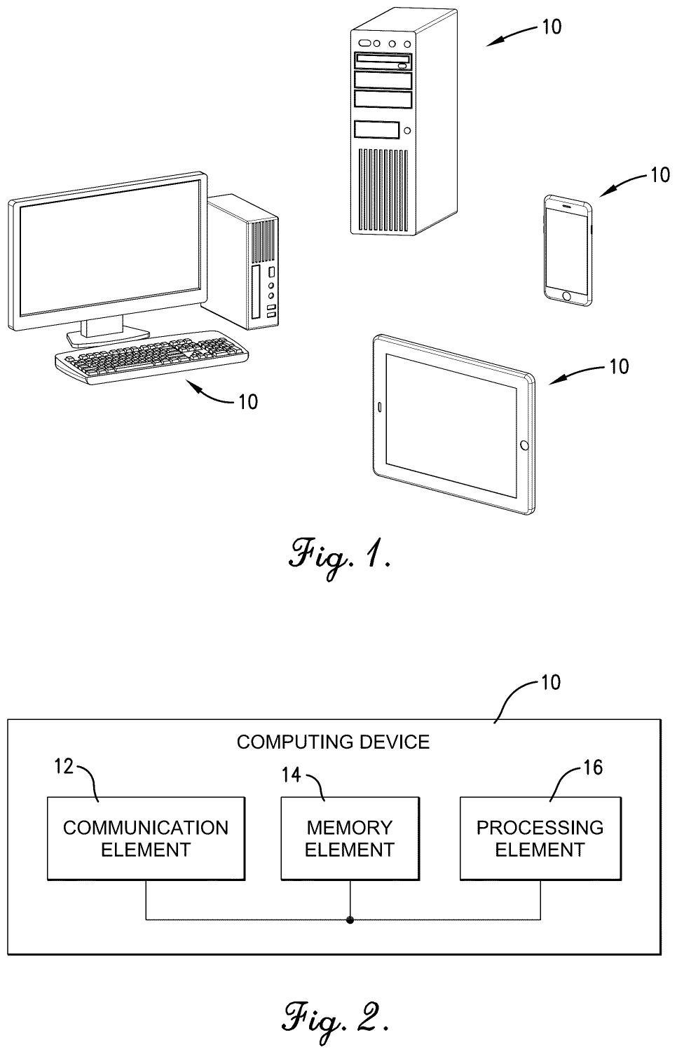

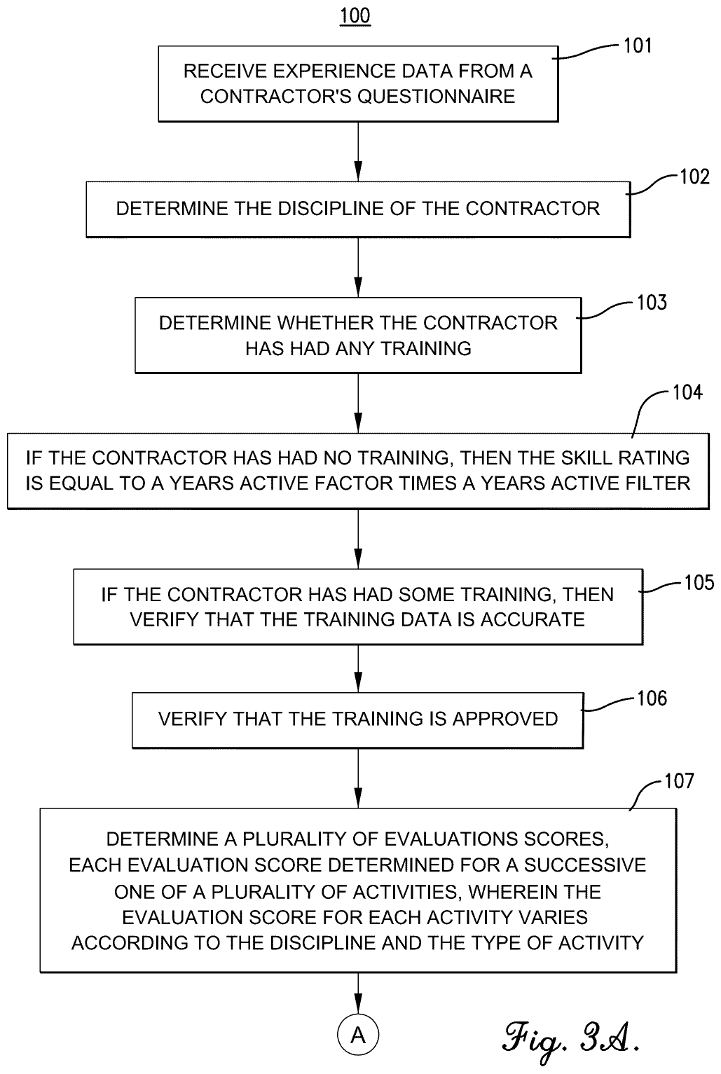

A computing device 10, constructed in accordance with various embodiments of the current invention, for determining and providing ratings of the skills of a contractor is shown in FIGS. 1 and 2. The computing device 10 may be embodied by any one or more of the electronic devices shown in FIG. 1, such as computer servers, workstation computers, desktop computers, laptop computers, palmtop computers, notebook computers, tablets or tablet computers, smartphones, mobile phones, cellular phones, or the like. The computing device 10 broadly comprises a communication element 12, a memory element 14, and a processing element 16.

The communication element 12 generally allows the computing device 10 to communicate with other computing devices, external systems, networks, and the like. The communication element 12 may include signal and/or data transmitting and receiving circuits, such as antennas, amplifiers, filters, mixers, oscillators, digital signal processors (DSPs), and the like. The communication element 12 may establish communication wirelessly by utilizing radio frequency (RF) signals and/or data that comply with communication standards such as cellular 2G, 3G, 4G, Voice over Internet Protocol (VOIP), LTE, Voice over LTE (VOLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 12 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 12 may establish communication through connectors or couplers that receive metal conductor wires or cables which are compatible with networking technologies such as ethernet. In certain embodiments, the communication element 12 may also couple with optical fiber cables. The communication element 12 may be in electronic communication with the memory element 14 and the processing element 16.

The memory element 14 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 14 may be embedded in, or packaged in the same package as, the processing element 16. The memory element 14 may include, or may constitute, a non-transitory “computer-readable medium”. The memory element 14 may store the instructions, code, code statements, code segments, software, firmware, programs, applications, apps, services, daemons, or the like that are executed by the processing element 16. The memory element 14 may also store data that is received by the processing element 16 or the device in which the processing element 16 is implemented. The processing element 16 may further store data or intermediate results generated during processing, calculations, and/or computations as well as data or final results after processing, calculations, and/or computations. In addition, the memory element 14 may store settings, data, documents, sound files, photographs, movies, images, databases, and the like.

The processing element 16 may comprise one or more processors. The processing element 16 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 16 may generally execute, process, or run instructions, code, code segments, code statements, software, firmware, programs, applications, apps, processes, services, daemons, or the like. The processing element 16 may also include hardware components such as registers, finite-state machines, sequential and combinational logic, configurable logic blocks, and other electronic circuits that can perform the functions necessary for the operation of the current invention. In certain embodiments, the processing element 16 may include multiple computational components and functional blocks that are packaged separately but function as a single unit. In some embodiments, the processing element 16 may further include multiprocessor architectures, parallel processor architectures, processor clusters, and the like, which provide high performance computing. The processing element 16 may be in electronic communication with the other electronic components through serial or parallel links that include universal busses, address busses, data busses, control lines, and the like.

The processing element 16 may be operable, configured, or programmed to perform the following functions by utilizing hardware, software, firmware, or combinations thereof. The processing element 16 receives data regarding a contractor experience including workshops, seminars, trainings, certifications, courses, classes, programs, apprenticeships, education, affiliations, memberships, and the like, that the contractor may attend which are related to a particular skill area and/or a particular industry or category of the industry. For example, the industry may be the floor covering industry, including categories of ceramic tile, carpet, resilient flooring, hardwood flooring, epoxy or polished concrete, and so forth. And the skill set may include the ability to install any one or more of the listed floor coverings, given that a skill to install one of the floor coverings does not necessarily extend to any of the other floor coverings. That is, a person trained to install one of the floor coverings is not necessarily able to install any of the other floor coverings without being trained to do so.

The data includes specific information about each contractor training regarding, among others, the environment, duration, content, and evaluation of the training. The environment may be virtual or in-person. For example, a training session or seminar may be virtual or online in which the contractor watches a recording or live video of an instructor teaching a particular skill, such as installing ceramic tile. Alternatively, the training session or seminar may be in-person in which the contractor attends a class and can interact one-on-one with the instructor. The duration defines a period of time for which the contractor training lasts, such as a one-day workshop or a multi-day or multi-week course. The content defines not only what is taught, such as the category of the industry, but also how it is taught. For example, the training may involve the contractor simply watching someone else perform a task, such as installing tile, or the training may allow the contractor to actually install the tile himself in a “hands on” manner. The evaluation defines how the contractor is graded for participation or performance. Some training, such as online training, may not actually be graded. Other training may involve a written test. Still other training may evaluate a hands-on performance by the contractor. Some of the testing may be pass/fail in nature. Some training may allow the contractor to retake a test after failing. Furthermore, some training may provide a certificate or certification for the contractor if he fulfills the requirements.

The data regarding contractor training is stored in the memory element 14 in a data storage structure, such as a database. The data is provided by the entity or association offering the contractor training. Or, the data may be provided by a third party who observed or attended the contractor training.

The processing element 16 assigns a numerical weight, a value level, or a ranking to each contractor training which varies according to, or is based on, the metrics associated with the environment, duration, content, and evaluation of the contractor training. Regarding the environment, generally, virtual or online environments are of lower weight than in-person environments because virtual or online environments remove the contractor from one-on-one interaction with the instructor and being able to perform any hands on tasks. Regarding the duration, generally, the weight is proportional to the duration of the contractor training such that a course that lasts for two weeks has a greater weight than a one-day workshop. Regarding the content, the weight is proportional to the level of participation of the contractor such that training in which the contractor actually performs a hands-on task as opposed to simply watching someone else do it has a higher weight. Regarding the evaluation, the weight is proportional to the level of evaluation such that training with no evaluation or grade generally has a relatively low weight, while training with a pass/fail or more stringent evaluation generally has a relatively high weight. A certificate or certification may also result in a higher weight.

The processing element 16 receives data from a contractor regarding his training and work experience, as well as contact information, residence information, working area, etc. The data may include answers from a questionnaire that the contractor filled out in order to receive a skill rating. The questionnaire may ask the contractor to list all of his training and work experience. The data may be received from a website that provides the questionnaire or from a mobile app or the like which includes the questionnaire. The data includes a listing of each contractor training that the contractor has attended. The data also includes a listing of a number of years of experience the contractor has had in the categories of the industry. For example, the contractor may have had some years of work experience installing various types of tile, but no experience in other categories.

The processing element 16 verifies that the data from the contractor regarding his contractor training and work experience is accurate. In some embodiments, the processing element 16 may request from the entity offering the contractor training a confirmation that the contractor registered, attended, or completed the contractor training and, if applicable, his evaluation or grade.

The processing element 16 approves the trainings provided by the contractor. It may be possible that one or more of the trainings attended by the contractor, for some reason, do not qualify to be considered in determining a skill rating for the contractor. In some embodiments, a listing, or database, of qualified contractor trainings may be stored in the memory element 14. The processing element 16 may compare the trainings from the contractor with the listing stored in the memory element 14 and approve those that match.

The processing element 16 determines a skill rating for the contractor. The skill rating may be determined as described below in the method 100. The processing element 16 may determine the skill rating of the contractor as a numeric value, such as a real number between 0 and the maximum value, e.g. 5, which can be displayed on a screen. Or, the processing element 16 may determine the skill rating of the contractor as a numeric value that is converted to, or represented by, one or more whole or fractional symbols or icons that are related to the industry and can be displayed on a screen. For example, in the industry of carpentry in general, or floor covering in particular, the symbol may be a hammer. Thus, the processing element 16 may determine the skill rating of the contractor as a plurality of whole and fractional hammers, such that a skill rating of, say, 2.25 would be represented by two whole hammers and one quarter of a hammer. Furthermore, the processing element 16 may determine the skill rating of the contractor using the method 100 for each discipline in which the contractor has had training. For example, the contractor may have had experience in carpet installation and hardwood flooring installation. Thus, the contractor have a first skill rating in carpet installation and a second skill rating in hardwood flooring installation.

The processing element 16 also receives additional data regarding training and experience from the contractor over time after the contractor has attended additional contractor trainings and/or has acquired more years of experience. The processing element 16 verifies the data and approves the qualified trainings. The processing element 16 then redetermines the skill rating for the contractor in the relevant categories.

Furthermore, the processing element 16 may receive data regarding trainings and years of work experience from a plurality of contractors. After the processing element 16 verifies the data and approves the qualified trainings, the processing element 16 determines a skill rating in each relevant category for each contractor. Thus, the processing element 16 creates a data storage structure, such as a database or a library, of rated contractors that includes a listing for each contractor who has submitted information, wherein the listing includes a skill rating for each category in which the contractor has had training or work experience.

In addition, the processing element 16 provides a website or software application for builders or contract managers to search for rated contractors as subcontractors. The website or software application allows a user (e.g., a builder) to enter the details for a work order describing a job for which one or more rated contractors may participate. Thus, the processing element 16 receives data regarding a category of work involved, a geolocation (e.g., a zip code) of the job, a radius from the job where the rated contractors should reside, information about the work that is needed to be performed, a number of rated contractors needed, and a skill rating for the contractor that the job requires, among others. Then, the processing element 16 searches the data storage structure for rated contractors who live within the radius of the geolocation and have the required minimum skill rating for the category of work specified. In some embodiments, contractors may also specify an area or region within which they are willing to work. The processing element 16 may also search the data storage structure for rated contractors who are willing to work in the geolocation area. For each match of rated contractor, the processing element 16 transmits a message that includes the details of the job to the rated contractor. The rated contractor then responds with one of a plurality of options including that he is interested in the job, he is declining the offer, and he would like to negotiate the terms. Therefore, the processing element 16 receives a response from each rated contractor and transmits the responses to the user who submitted the work order.

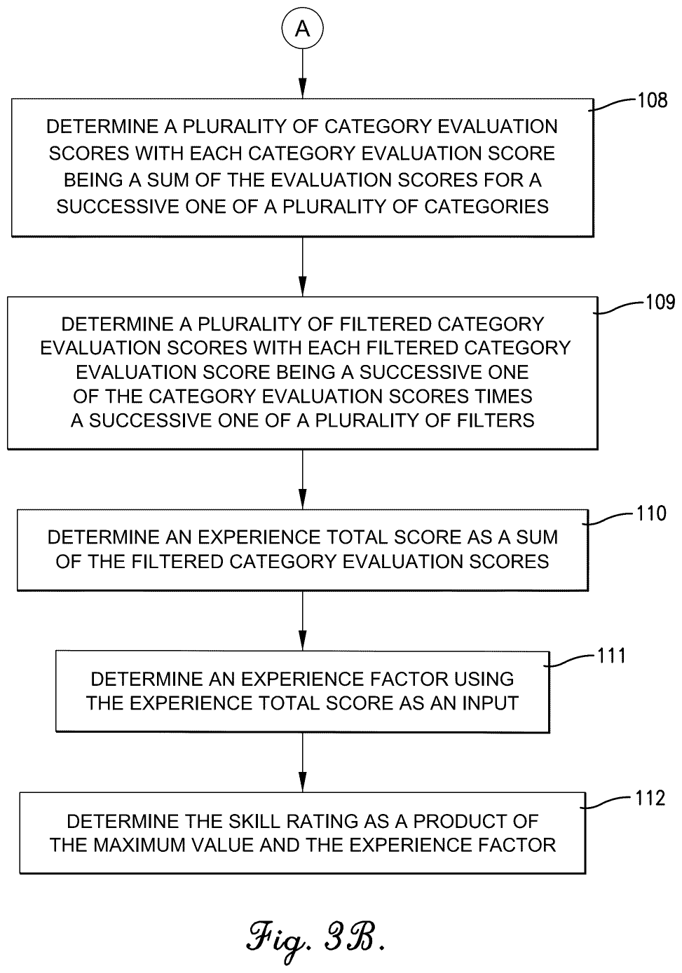

FIGS. 3A and 3B depicts a listing of at least a portion of the steps of an exemplary computer-implemented method 100 for determining a skill rating of a contractor. The steps may be performed in the order shown in FIGS. 3A and 3B, or they may be performed in a different order. Furthermore, some steps may be performed concurrently as opposed to sequentially. In addition, some steps may be optional or may not be performed. The steps may be performed by the processing element 16 of the computing device 10 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as the memory element 14.

Referring to step 101, data is received from a contractor's questionnaire regarding his professional experience. The questionnaire may ask the contractor to list all of his training and work experience. The data may be received from a website that provides the questionnaire or from a mobile app or the like which includes the questionnaire. The data includes a listing of each contractor training that the contractor has attended and affiliations, memberships, and so forth. The data also includes a listing of a number of years of experience the contractor has had in the categories of the industry. The data is stored in the data storage structure in the memory element 14 so that the processing element 16 can track properties such as years of experience and update the values as time goes by.

Referring to step 102, a discipline of the contractor is determined. Typically, the contractor works in one of a plurality of disciplines, although it is possible that he has worked in, had training in, or been affiliated with, multiple disciplines. An industry of the contractor may also be determined. The computing device 10 and method 100 of the current invention may be utilized or implemented to determine the skill rating of a contractor in any industry, although the flooring industry is presented as an example of how the current invention is implemented. In the flooring industry, disciplines may include ceramic tile, carpet, resilient flooring, hardwood flooring, epoxy or polished concrete, and so forth. The discipline of the contractor may be explicitly stated in the questionnaire or may be determined from the type of training sessions, affiliations, and memberships he has had.

Referring to step 103, it is determined whether the contractor has had any training. The contractor may be new to the field or may have worked for a while without any formal training courses.

Referring to step 104, if the contractor has had no training, then the skill rating is equal to a years active factor times a years active filter. The years active factor varies non-linearly according to a number of years that the contractor has been active or working in the industry. In some embodiments, the years active factor may be determined using a lookup table, wherein the lookup table includes a plurality of different years active factor values. Each years active factor value may be referenced by the number of years that the contractor has been active or by a range of the number of years that the contractor has been active. For example, if the contractor has been active or working for between 10 and 11 years, then the value of the years active factor is 4. In other embodiments, the years active factor may be determined by solving a non-linear arithmetic equation using the number of years that the contractor has been active as an input. That is, the years active factor is determined as a non-linear function of the number of years that the contractor has been active. The non-linear function may be exponential, inverse exponential, logarithmic, or the like.

The years active filter is typically expressed as a percentage, such as 10%. To continue the example and calculate the skill rating, the skill rating is equal to 4×0.10=0.40.

Referring to step 105, if the contractor has had some training, then the data regarding training is verified as being accurate. The training or training sessions may include formal education, product training, workshops, seminars, courses, classes, programs, certifications, apprenticeships, and the like. Also considered with training are affiliations, memberships, and so forth. The processing element 16 may request from the entity offering the contractor training sessions a confirmation that the contractor registered, attended, or completed the contractor training session and, if applicable, his evaluation or grade. The processing element 16 may also verify affiliations, and memberships. If any of the training data is not accurate, then that training session, affiliation, or membership is removed from the training data.

Referring to step 106, the training attended by the contractor are verified as being approved. It may be possible that one or more of the training sessions attended by the contractor or the affiliations, or memberships, for some reason, do not qualify to be considered in determining a skill rating for the contractor. In some embodiments, a listing, or database, of qualified contractor training sessions, affiliations, and memberships may be stored in the memory element 14. The processing element 16 may compare the training sessions, affiliations, and memberships from the contractor with the listing stored in the memory element 14 and approve those that match. If any of the training data is not approved, then that training session, affiliation, or membership is removed from the training data.

Referring to step 107, a plurality of evaluation scores is determined. One evaluation score is determined for each of the training sessions, affiliations, and memberships had by the contractor. Each of the activities has a specific value. That is, the evaluation score for each training session, affiliation, membership, and the like has a specific value. Furthermore, the value of the evaluation score for each of the listed activities varies according to the discipline. For example, a training session, affiliation, or membership for installing carpet has a different evaluation score value compared with a training session, affiliation, or membership for installing hardwood flooring. In addition, the value of the evaluation score for any given training session may vary according to factors like a level of subject matter, a type of testing that is done to determine whether the installer has retained the instruction material, whether continuing education or a renewal is required, how many hours of classroom training and hands-on training are provided, how long the training session has been offered, etc. For example, the evaluation score for a beginner level training session has a lower value than an intermediate level training session which has a lower value than an advanced training session. The evaluation score for a training session that gives a test has a higher value than a training session that has no test. The evaluation score for a training session that requires the installer to pass the test in order to get credit has a higher value than the training session that simply gives the test. The evaluation score for a training session that requires continuing education has a higher value than a training session that does not require continuing education. The frequency of the continuing education also influences the value of the evaluation score. That is, the value of the evaluation score for a training session that requires a yearly continuing education has a higher value than a training session that requires continuing education every two years. The value of the evaluation score varies according to the number of hours of classroom training and hands-on training that are provided-generally with a greater number of hours having a higher score. The of the evaluation score value also varies according to the number of years the training session has been offered-generally with a greater number of years having a higher score. In some instances, one or more aspects of a training session may have a negative value. For example, if a training session allows retakes of the test, then the total value of the evaluation score for the particular training session may be reduced. If a training session allows unlimited retakes of the test, then the total value of the evaluation score for the particular training session may be reduced further.

Referring to step 108, a plurality of category evaluation scores is determined. Each category evaluation score is a sum of the evaluation scores for a successive one of a plurality of categories. The categories are broader groupings of the activities discussed in step 107 and include certifications, memberships or affiliations, micro trainings, and apprenticeships, such as Department of Labor (DOL) apprenticeships. Each of the activities discussed in step 107 falls into one of the four categories, although having a different number of categories is within the scope of the current invention. Thus, all of the evaluation scores that fall into the certifications category are added together to create a certifications category evaluation score. All of the evaluation scores for memberships or affiliations are added together to create a affiliations category evaluation score. All of the evaluation scores that fall into the micro trainings category are added together to create a micro trainings category evaluation score. All of the evaluation scores that fall into the DOL apprenticeship category are added together to create a DOL apprenticeship category evaluation score.

Referring to step 109, a plurality of filtered category evaluation scores is determined. Each category evaluation score is multiplied by a successive one of plurality of filters. Also included as a category evaluation score is a years active factor like the one calculated in step 103. The years active factor calculated in step 103 is calculated for the situation in which the contractor has had no training. But, the years active factor is also calculated for the contractor who has had some training, and it is calculated in the same way, using a lookup table or non-linear arithmetic equation.

The filters have a specific value for each category. An example of the values is as follows. A certifications filter has a value of 75%. An affiliations filter has a value of 40%. A micro trainings filter has a value of 8%. An apprenticeship filter has a value of 75%. And, as discussed in step 103, the years active filter has a value of 10%. Thus, a certifications filtered category evaluation score equals the certifications category evaluation score times 0.75. An affiliations filtered category evaluation score equals the affiliations category evaluation score times 0.40. A micro trainings filtered category evaluation score equals the micro trainings category evaluation score times 0.08. An apprenticeship filtered category evaluation score equals the apprenticeship category evaluation score times 0.75. A years active category evaluation score equals the years active factor times 0.10.

Referring to step 110, an experience total score is determined. The experience total score is a sum of the filtered category evaluation scores. Thus, the experience total score is equal to the certifications filtered category evaluation score plus the affiliations filtered category evaluation score plus the micro trainings filtered category evaluation score plus the DOL apprenticeship filtered category evaluation score plus the years active category evaluation score.

Referring to step 111, an experience factor is determined. The experience factor varies non-linearly according to the experience total score. In some embodiments, the experience factor may be determined using a lookup table, wherein the lookup table includes a plurality of different experience factor values. Each experience factor value may be referenced by the experience total score or by a range of experience total scores. For example, if the experience total score is greater than or equal to 2.5 and less than 3.25, then the value of the experience factor is 58%. In other embodiments, the experience factor may be determined by solving a non-linear arithmetic equation using the experience total score as an input. That is, the experience factor is determined as a non-linear function of the experience total score. The non-linear function may be exponential, inverse exponential, logarithmic, or the like.

Referring to step 112, the skill rating is determined as a product of the maximum value of the skill rating and the experience factor.

The skill rating may be redetermined following steps 101-112 whenever the contractor updates his experience data, such as taking additional training, maintaining a certification, becoming a member of another trade group, and so forth.

An example of calculating the skill rating is as follows, assuming that the contractor has two certifications, has memberships and affiliations, has attended six training sessions, has had an apprenticeship, and has worked for 10 years. (Also assumed is that the contractor's submitted training data is accurate and approved.) From steps 107 and 108, the exemplary certifications have a category evaluation score of 3.6 (two certifications each having an evaluation score of 1.8). The exemplary affiliation has a category evaluation score of 0.3. The exemplary micro trainings have a category evaluation score of 3 (six micro trainings, each having an evaluation score of 0.5). The exemplary apprenticeship has a category evaluation score of 2.0.

From step 109, the certifications filtered category evaluation score equals 3.6×0.75=2.7. The affiliations filtered category evaluation score equals 0.3×0.4=0.12. The micro trainings filtered category evaluation score equals 3×0.08=0.24. The apprenticeship filtered category evaluation score equals 2.0×0.75=1.5. The years active category evaluation score equals 4×0.10=0.4.

From step 110, the experience total score equals 2.7+0.12+0.24+1.5+0.4=4.56.

From step 111, the experience factor (determined from a lookup table with 4.56 as an input) is 82%.

From step 112, the skill rating equals 5×0.82=4.1. Thus, the skill rating for the contractor in the given discipline, such as carpet installation, represented in terms of hammers would be four whole hammers and one tenth of a hammer.

The skill rating is based directly on a contractor's experience including training sessions, affiliations, and memberships with and is determined with more weight given to training sessions that are more stringent. This gives builders, contract managers, or anyone who wants to hire a contractor a more accurate and objective assessment of the contractor's skills.

Embodiments of the current invention also provide a computer-implemented method for determining and providing ratings of the skills of a contractor. The steps of the method may be performed by the processing element 16 and are derived from the functioning of the processing element 16 discussed above.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

1. A computer-implemented method of compiling and weighting disparate types of data associated with contracting skill levels for generating a data storage structure comprising a determined skill rating of each of a plurality of contractors, the method comprising:
receiving experience data and training data regarding each contractor's professional experience;
determining, for each contractor, whether there is any training data;
if there is no training data, then determining, for each contractor, the respective skill rating as a product of a years active factor and a years active filter;
if there is some training data, then performing the following for each contractor:
determining a plurality of training scores, each training score determined for a respective one of a plurality of activities related to the training data,
determining a plurality of category training scores, each category training score being a sum of the training scores for a respective one of a plurality of categories,
determining a plurality of filtered category training scores, each filtered category training score being a product of a respective one of the category training scores and a respective one of a plurality of filters,
determining an experience total score as a sum of the filtered category training scores,
determining an experience factor using the experience total score as an input, and
determining the skill rating as a product of the maximum value of the skill rating and the experience factor; and
inputting the determined skill rating into a data storage structure of skill rating entries associated with each of the contractors.

2. The computer-implemented method of claim 1, further comprising if the contractor has had some training, then verifying that the training data is accurate and removing any training data that is not accurate.

3. The computer-implemented method of claim 1, further comprising if the contractor has had some training, then verifying that the training data is approved and removing any training data that is not approved.

4. The computer-implemented method of claim 1, further comprising if the contractor has had some training, then determining a discipline of the contractor.

5. The computer-implemented method of claim 4, wherein a value of each training score varies according to the discipline.

6. The computer-implemented method of claim 1, wherein a portion of the training scores are associated with a plurality of training sessions and a value of each of the portion of training scores varies according to a level of subject matter of the associated training session.

7. The computer-implemented method of claim 1, wherein a portion of the training scores are associated with a plurality of training sessions and a value of each of the portion of training scores varies according to a type of testing for the associated training session.

8. The computer-implemented method of claim 1, wherein a portion of the training scores are associated with a plurality of training sessions and a value of each of the portion of training scores varies according to whether continuing education is required for the associated training session.

9. The computer-implemented method of claim 1, wherein a portion of the training scores are associated with a plurality of training sessions and a value of each of the portion of training scores varies according to a number of hands-on training hours are provided for the associated training session.

10. The computer-implemented method of claim 1, wherein a portion of the training scores are associated with a plurality of training sessions and a value of each of the portion of training scores varies according to a period of time that the associated training session has been offered.

11. The computer-implemented method of claim 1, wherein a value of each filter varies according to the category.

12. The computer-implemented method of claim 1, wherein the experience factor is determined using a lookup table that includes a plurality of experience factor values, each experience factor value being referenced by a range of experience total score values.

13. The computer-implemented method of claim 1, wherein a value of the experience factor varies non-linearly with the experience total score.

14. A computer-implemented method of compiling and weighting disparate types of data associated with contracting skill levels for generating a data storage structure comprising a determined skill rating of each of a plurality of contractors, the method comprising:
receiving experience data and training data regarding each contractor's professional experience;
determining a discipline of each contractor;
determining, for each contractor, whether there is any training data;
if there is no training data, then determining, for each contractor, the respective skill rating as a product of a years active factor and a years active filter;
if there is some training data, then performing the following for each contractor:
verifying that the training data is accurate,
verifying that the training data is approved,
determining a plurality of training scores, each training score determined for a respective one of a plurality of activities related to the training data,
determining a plurality of category training scores, each category training score being a sum of the training scores for a respective one of a plurality of categories,
determining a plurality of filtered category training scores, each filtered category training score being a product of a respective one of the category training scores and a respective one of a plurality of filters,
determining an experience total score as a sum of the filtered category training scores,
determining an experience factor using the experience total score as an input, and
determining the skill rating as a product of the maximum value of the skill rating and the experience factor; and
inputting the determined skill rating into a data storage structure of skill rating entries associated with each of the contractors.

15. The computer-implemented method of claim 12, further comprising if the contractor has had some training, then removing any training data that is not accurate and removing any training data that is not approved.

16. The computer-implemented method of claim 12, wherein a value of each training score varies according to the discipline.

17. The computer-implemented method of claim 12, wherein a value of each filter varies according to the category.

18. The computer-implemented method of claim 12, wherein the experience factor is determined using a lookup table that includes a plurality of experience factor values, each experience factor value being referenced by a range of experience total score values.

19. The computer-implemented method of claim 12, wherein a value of the experience factor varies non-linearly with the experience total score.

20. A computer-implemented method of compiling and weighting disparate types of data associated with contracting skill levels for generating a data storage structure comprising a determined skill rating of each of a plurality of contractors, the method comprising:
receiving experience data and training data regarding each contractor's professional experience;
determining a discipline of each contractor;
determining, for each contractor, whether there is any training data;
if there is no training data, then determining, for each contractor, the respective skill rating as a product of a years active factor and a years active filter;
if there is some training data, then performing the following for each contractor:
verifying that the training data is accurate,
removing any training data that is not accurate,
verifying that the training data is approved,
removing any training data that is not approved,
determining a plurality of training scores, each training score determined for a respective one of a plurality of activities related to the training data, a value of each training score varying according to the discipline,
determining a plurality of category training scores, each category training score being a sum of the training scores for a respective one of a plurality of categories,
determining a plurality of filtered category training scores, each filtered category training score being a product of a respective one of the category training scores and a respective one of a plurality of filters, a value of each filter varying according to the category,
determining an experience total score as a sum of the filtered category training scores,
determining an experience factor using the experience total score as an input,
determining the skill rating as a product of the maximum value of the skill rating and the experience factor; and
inputting the determined skill rating into a data storage structure of skill rating entries associated with each of the contractors.
